(19) United States
(12) Patent Application Publication
(10) Pub. No.: US 2024/0330834 A1
(43) Pub. Date: Oct. 3, 2024

(54) ARTIFICIAL INTELLIGENCE BASED LEARNING PATH GENERATOR AND INTERACTIVE GUIDE

(71) Applicant: Accenture Global Solutions Limited, Dublin (IE)

(72) Inventors: Sanjay Tiwari, Bengaluru (IN); Anshul Kapoor, Delhi (IN); Ravi Shankar Nori, Bangalore (IN)

(21) Appl. No.: 18/192,058

(22) Filed: Mar. 29, 2023

(51) Int. Cl. G06Q 10/0639; G06Q 10/0631; G06Q 10/1053

(52) U.S. Cl. CPC G06Q 10/06398; G06Q 10/063112; G06Q 10/063118; G06Q 10/1053

(57) ABSTRACT

Intelligent machine learning-based systems and methods of generating recommendations for individualized skill development. The system and method offer an automated framework by which organizations can easily pre-screen bulk profiles, hire based on region and projects, and provide employees with a skill upgrade program to enhance their capabilities. The system can use natural language processing techniques to ingest and process candidate and job data and machine learning techniques to identify the degree to which the skills of each candidate match the organization's available roles. In some embodiments, the framework facilitates a bench reduction program that helps optimize the workforce by identifying underutilized employees and help organizations build a strong, capable workforce that can achieve their current and future goals.

### TECHNICAL FIELD

The present disclosure generally relates to building an interactive system for promoting specific skillsets in personnel, and more particularly to using machine learning (ML) to generate learning paths and interactively guide individuals to enhance the individuals' ability to fill high-demand opportunities and roles.

### BACKGROUND

There is a growing demand in the market for personnel who are adept across a diverse combination of domain, technology, and cloud expertise. Yet current upskilling approaches do not adequately address the gap between the actual skill sets available and increasingly dynamic project requirements. Organizations are realizing that achieving a competitive advantage is not primarily dependent, as has been traditionally assumed, on natural resources, technology, or economies of scale, as these are increasingly easy to imitate. Instead, the competitive advantage is ever more dependent on the valuable, scarce, and hard to imitate resources that reside within the organization as individual personnel. Organizations must ensure they have the necessary people in place to meet their current and future business priorities and as such, there is a need to ensure that talent is effectively and proactively identified, developed, managed, and retained. However, when large organizations have thousands of employees and hundreds of job openings, it can be difficult to identify the individual employees skills, assess their development, and match employees to job openings.

There is a need in the art for a system and method that addresses the shortcomings discussed above.

### SUMMARY

The proposed systems and methods describe a dynamic and automated process for generating learning paths and recommendations for improving talent management. The system and method solve the problems discussed above by providing a framework by which organizations can easily pre-screen bulk profiles, hire based on region and projects, and provide employees with a skill upgrade program to enhance their capabilities. The system can use natural language processing techniques to ingest and process candidate and job data and machine learning techniques to identify the degree to which the skills of each candidate match the organization's available roles. In some embodiments, the framework offers a bench reduction program that helps optimize the workforce by identifying underutilized employees and help organizations build a strong, capable workforce that can achieve their goals. The framework facilitates a more efficient, accurate, consistent, and customized promotion of human capital by intelligent assessments that lead to the offering of meaningful upskill opportunities that are tailored to the candidate's background and capability. Furthermore, the system can predict the amount of time (duration) that will be realistically required for each candidate to become proficient in a target skill, allowing the organization to adapt to their future needs through a crafted sequence of individual talent development and growth. In some examples, the framework can respond dynamically to real-time inputs, allowing changes in the candidate's abilities and skillset evaluation to modify the recommended learning path for that candidate. For example, human mentors proficient in a skill that is recommended by the system can be assigned to the candidate, and feedback by the human mentor can cause the system to responsively add or remove training modules from the candidate's recommended learning path. The system is dynamic and can update the learning path based on the mentor's feedback and/or changes in the candidate's proficiency (e.g., as identified through testing), experience, and/or education.

In one aspect, the disclosure provides a computer implemented a method of controlling a system to generate and interactively implement a customized learning path. The method includes a first step of receiving, at a talent management system, a first candidate description for a first candidate including a first skillset, and a second step of receiving, at the talent management system, a dataset including a plurality of job descriptions. A third step includes determining, via a first machine learning model of the talent management system, the first candidate description with the first skillset matches a first percentage of job descriptions from the plurality of job descriptions, the first percentage falling below a first threshold. In addition, a fourth step includes determining, via a second machine learning model of the talent management system, the first skillset includes at least a first skill that corresponds to a second skill in a skill repository. A fifth step includes selecting, at the talent management system and by reference to the skills repository, a third skill that the first candidate currently lacks, the third skill selected based on its relationship to one or more of certifications, experiences, domain knowledge, aspirations, and personality traits associated with the first candidate. Furthermore, a sixth step includes determining, at the talent management system, the first skill in combination with the third skill increases the number of matching job descriptions, and a seventh step includes presenting to a user, via an interface display of the talent management system, a recommendation that a first training module targeting the third skill be completed by the first candidate.

In another aspect, the disclosure provides a non-transitory computer-readable medium storing software comprising instructions executable by one or more computers which, upon such execution, cause the one or more computers to: (1) receive, at a talent management system, a first candidate description for a first candidate including a first skillset; (2) receive, at the talent management system, a dataset including a plurality of job descriptions; (3) determine, via a first machine learning model of the talent management system, the first candidate description with the first skillset matches a first percentage of job descriptions from the plurality of job descriptions, the first percentage falling below a first threshold; (4) determine, via a second machine learning model of the talent management system, the first skillset includes at least a first skill that corresponds to a second skill in a skill repository; (5) select, at the talent management system and by reference to the skills repository, a third skill that the first candidate currently lacks, the third skill selected based on its relationship to one or more of certifications, experiences, domain knowledge, aspirations, and personality traits associated with the first candidate; (6) determine, at the talent management system, the first skill in combination with the third skill increases the number of matching job descriptions; and (7) present to a user, via an interface display of the talent management system, a recommendation that a first training module targeting the third skill be completed by the first candidate.

In yet another aspect, the disclosure provides a system for producing enriched test data, the system comprising one or more computers and one or more storage devices storing instructions that may be operable, when executed by the one or more computers, to cause the one or more computers to: (1) receive, at a talent management system, a first candidate description for a first candidate including a first skillset; (2) receive, at the talent management system, a dataset including a plurality of job descriptions; (3) determine, via a first machine learning model of the talent management system, the first candidate description with the first skillset matches a first percentage of job descriptions from the plurality of job descriptions, the first percentage falling below a first threshold; (4) determine, via a second machine learning model of the talent management system, the first skillset includes at least a first skill that corresponds to a second skill in a skill repository; (5) select, at the talent management system and by reference to the skills repository, a third skill that the first candidate currently lacks, the third skill selected based on its relationship to one or more of certifications, experiences, domain knowledge, aspirations, and personality traits associated with the first candidate; (6) determine, at the talent management system, the first skill in combination with the third skill increases the number of matching job descriptions; and (7) present to a user, via an interface display of the talent management system, a recommendation that a first training module targeting the third skill be completed by the first candidate.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is an overview of an embodiment of a process for automated management of talent in an organization;

FIGS. 2 and 3 are a sequence of schematic diagrams that collectively depict a high-level view of a process for a talent management system, according to an embodiment;

FIG. 4 is a schematic diagram of a machine learning model training and predicting architecture, according to an embodiment;

FIG. 5 is an example of a first user interface for an application of the talent management system presenting information for a candidate, according to an embodiment;

FIG. 6 is an example of a second user interface for the application of the talent management system presenting an assessment, according to an embodiment;

FIG. 7 is an example of a third user interface for the application of the talent management system presenting a score dashboard a candidate, according to an embodiment;

FIG. 8 is an example of a fourth user interface for the application of the talent management system presenting a recommended learning path for a candidate including a sequence of training modules, according to an embodiment;

FIG. 9 is an example of a fifth user interface for the application of the talent management system presenting activity information for a candidate, according to an embodiment;

FIG. 10 is a flow chart depicting a method of proactively managing and promoting human technical skills, according to an embodiment; and

FIG. 11 is a diagram depicting example environments and components by which systems and/or methods, described herein, may be implemented.

### DESCRIPTION OF EMBODIMENTS

The advances in digital technology in the last three decades created an Information Technology (IT) revolution and caused an exponential increase in number of hardware devices and associated software. Information technology is a term that broadly describes the development, installation and implementation of computer and telecommunication systems and applications. IT has enabled the application of digital technologies across a wide spectrum of domains including education, entertainment, transportation, communications, medicine, agriculture, law, banking, and finance. This has positively impacted the lives of ordinary people and helped them to increase productivity and efficiency. The new technologies have also created new fields, new types of employment and new IT enterprises, all requiring a different kind and range of skill set. These enterprises rapidly multiplied the creation of software and hardware products for the IT market, particularly in the realm of telecommunications or communication service providers (CSPs) such as telcos that are used to transport information electronically through telephony and data communication services in the networking industry and/or serve as Internet service providers (ISPs). However, the speed of change in these fields have also highlighted a growing resource and skill shortage.

Indeed, in many cases, the advances and changes in the IT industry are so rapid that some of the topics and methodologies that may be of use at one time and absorbed by students become outdated within only a few years. For purposes of this application, the terms “information skill gap” or “knowledge gap” refer to the perceived mismatch between the quality and adequacy of skills possessed by a potential or current candidate or employee and what is actually needed by the industry. The IT skills gap in particular can have a significant impact on organizations as a whole, particularly when the gap becomes so great or widespread that the organization can no longer grow or remain competitive because it cannot fill critical jobs with employees who have the right knowledge, skills, and abilities, reducing the industry's productivity. In many cases, a person may have one subset of skills that is desirable, but lack the combination or bundle of different skill subsets that would make them suitable for a given role.

The proposed systems and methods are directed to the automated, intelligent management and support of individuals in adapting and growing their skill set across a dynamic knowledge landscape. In one example, the system can support talent building and predict an individual's potential future roles based on their existing skill sets, certifications, work experience, domain knowledge, and aspirations. The proposed approach incorporates information based on unique combinations and external factors that may impact career growth that extend far beyond traditional performance metrics. As will be discussed below, the proposed embodiments can provide organizations with a powerful machine learning (ML)-based framework that automatically highlights the alignment of employee capabilities and career aspirations with the company's business strategy and talent needs. In one embodiment, the system enables organizations to avoid costly mistakes in hiring, talent development, and allows for the promotion of appropriately skilled employees for each role. It can be appreciated that in different embodiments, this talent management tool will help sustain internal pools of possible successors for every critical and non-critical role, help define skills required for the success of the organization both in the present and toward the future, identify motivated employees based on their investment in their career growth, and improve employee retention rates.

In different embodiments, the framework incorporates knowledge modules for niche areas, subject matter expert (SME) demonstrations, and hands-on labs that can impart the most up-to-date telco or other cloud-related skills. In some embodiments, the framework can leverage selective external trainings that focus on key areas (such as, but not limited to, 5G, cloud, network automation, etc.) to upskill organizational resources for upcoming global opportunities in the telco space, as well as other future dynamic technological spaces. In one example, the framework can serve as a talent engine powered by SMEs and databases to provide readily available talent resources or skills upgrading for any new opportunities, streamlining the process of bridging the knowledge gaps, and reducing onboarding times. The framework can align an organization's current requirements to its future needs, and with iterative changes will refine this engine incrementally to produce a flux of ready-to-deploy seed teams, for example by ongoing implementation of new modules and relevant external trainings to its repository. In some embodiments, this updated knowledge would include information sharing among participants in the manner of teach-back sessions for the subsequent batches, promoting a growth-mindset.

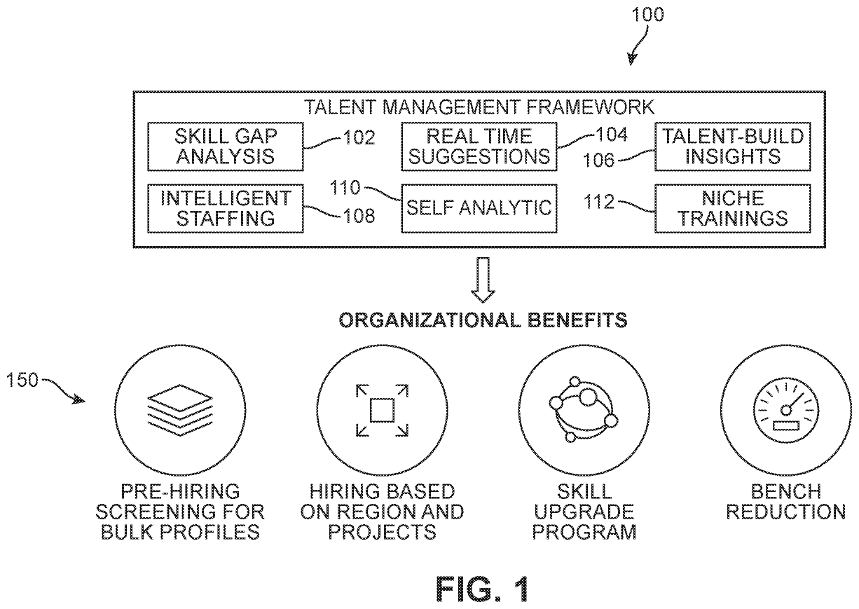

As discussed above, in different embodiments, the proposed systems and methods can foster proactive skill building and future-ready human resources using an ML-based talent engine. Referring first to FIG. 1, an overview of some of the features and benefits of the proposed embodiments is depicted. As shown in FIG. 1, a talent management framework 100 can offer an array of features, including but not limited to a comprehensive and individualized skill gap analysis 102 for each employee, real-time suggestions and recommendations 104 that are targeted to the most up-to-date ongoing and anticipated needs of the organization, talent-build insights 106 tailored to guiding different levels of managers and employees and recommend learning paths for each person, intelligent staffing solutions 108 that intelligently identify or select the most appropriate or best-fit personnel for training and development toward specific goals or opportunities, self-analytic feedback 110 that allows each individual to review their current skill set status and appreciate a sense of the big-picture regarding where they can best direct their efforts going forward, as well as niche training resources 112 whereby the desired skills can be specifically accommodated and promoted. The result of implementation of this framework at the organization level can provide a range of benefits 150, including but not limited to a pre-hiring screening tool for handling bulk profiles, hiring based on regional availability and project needs, a skill upgrade program that can be tailored to each person's desired target(s), and bench reduction where personnel can be distributed across the organization in a manner that optimizes their contribution and participation.

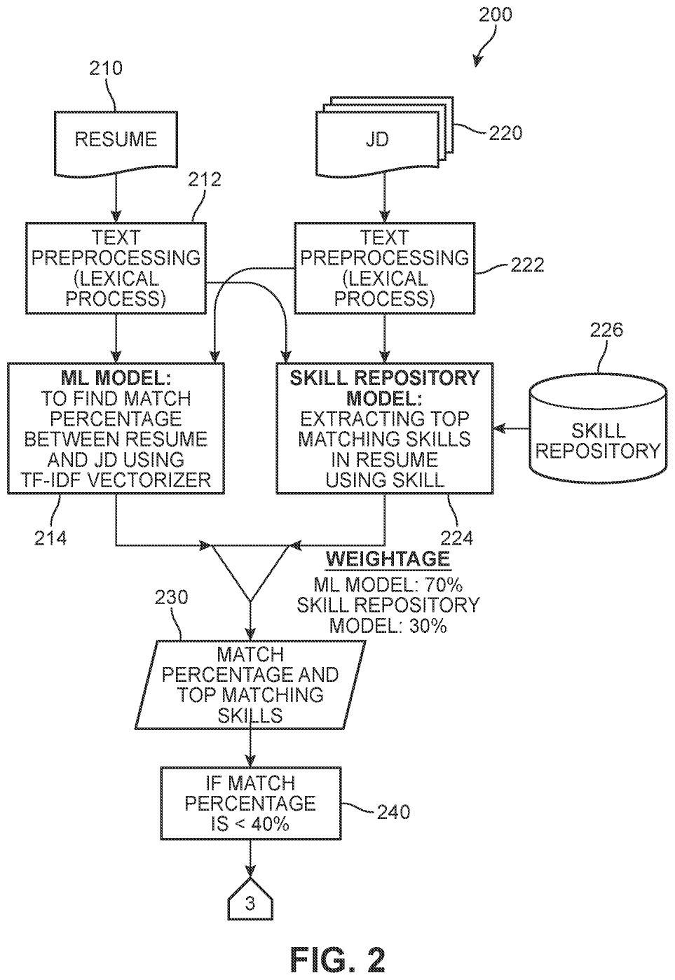

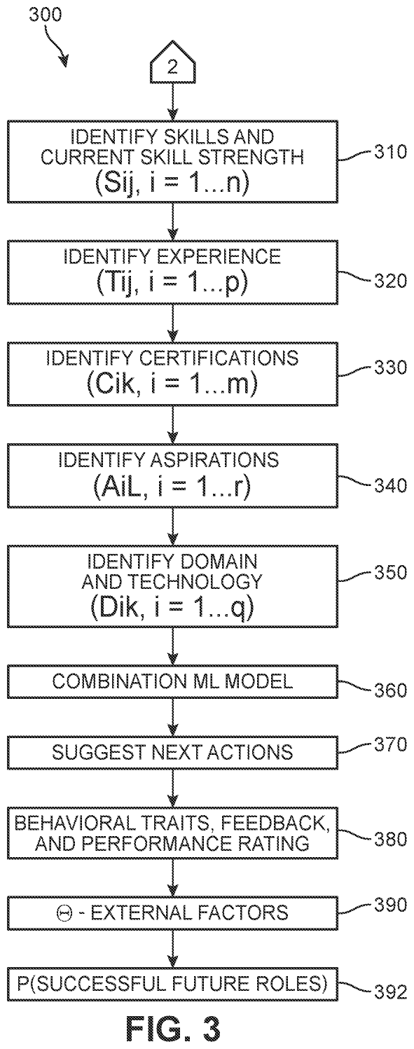

Referring now to FIGS. 2 and 3, a high-level view of an embodiment of a flow through a technical architecture (“architecture”) 200 and 300 for prediction of an individual's potential future roles is depicted. As will be described below, in different embodiments, this prediction can be based on, for example, the individual's existing skill sets, certifications, work experience, domain knowledge, and aspirations. The prediction further encompasses not just traditional performance metrics but unique skill combinations and external factors that may impact career growth. As shown in FIG. 2, during a first phase, the architecture 200 can first receive various inputs including a candidate description (e.g., a candidate profile or resume 210) and a plurality of job descriptions (jobs dataset, or simply “JD”) 220 for roles or potential upcoming and currently available opportunities in the organization. In different embodiments, the resume 210 can undergo text-based (lexical) pre-processing 212 and the JD 220 can also undergo text-based (lexical) pre-processing 222.

The output of the pre-processing stage for each input type can then be shared with a match ML model 214 and a skill repository ML model 224. In some embodiments, the match ML model 214 can receive the preprocessed data and determine the percentage by which the resume and JD represent a match or have correspondence. In some embodiments, the match ML model 214 can implement a term frequency-inverse document frequency (TF-IDF) vectorizer or other text classification and natural language processing (NLP) models that identify words that appear in the same context (e.g., continuous Bag-of-Words model (CBOW), Word2Vec, genism, Skip-Gram, etc.). For example, in one embodiment, the method may include determining that the first candidate description with the first skillset matches a first percentage of job descriptions from the plurality of job descriptions by converting the candidate description and the plurality of job descriptions to vectors and comparing similarity between the vectorized first candidate description and each vectorized job description of the plurality of job descriptions. In this way, the match ML model 214 can intelligently approximate the degree to which the particular candidate is suited to or an appropriate fit for the jobs that are listed in the JD 220. It can be appreciated that some candidates with a broad range of skills may have many job matches and the model will then output a relatively high match percentage, while some other candidates with a more narrow range of skills may have few or even no job matches and the model will then output a relatively low match percentage. In other words, the magnitude of the percentage generated by the match ML model 214 represents the extent of the candidate's knowledge gap as relevant to the organization—the higher the percentage, the smaller the knowledge gap, and the less likely that candidate is to require an upskilling program.

In addition, in some embodiments, the skill repository ML model 224 can receive the preprocessed data of both input types and identify and extract the candidate's current skillset (comprising one or more skills in which-based on the candidate description—it appears he or she is currently proficient in). The skill repository ML model 224 can then determine whether any of the skills in the candidate's skillset match at least some of the skills that are needed for the upcoming jobs/roles. In some embodiments, skill repository ML model 224 can access a skills repository 226 which represents skills harvested from a large set of job descriptions to identify matches.

In different embodiments, outputs 230 of the match ML model 214 and the skill repository ML model 224 can be combined by the system for further processing down the pipeline. In some embodiments, the organization can determine the relative significance of the two types of outputs by modifying the weights assigned to each. In some embodiments, the organization may place greater importance on how much the current skillset of the candidate matched the JD, and assign a weight greater than 50% to the results of the match ML model 214. In one example, the most effective results were obtained when the weight was set to 70%. Similarly, in some embodiments, the organization may place relatively smaller importance on the top matching skills between the candidate description and the skill repository and assign a weight less than 50% to the results of the skill repository ML model 224. In one example, the most effective results were obtained when the weight was set to 30%. In other cases, the scenario may be reversed, and more weight assigned to the skill repository ML model 224 relative to the match ML model 214.

In some embodiments, the system can identify whether the match percentage generated by ML model 214 was below a pre-selected threshold, and based on that threshold, the data can be moved forward. In some embodiments, the threshold can be between 30% and 60%, depending on the desired development goals and alignment levels of the organization. For purposes of this example, if the outputted match percentage was less than 40% for the candidate, the system can move into a second phase where a set of operations designed to pinpoint the candidate's skill set and potential is performed in order to optimize the selections for his/her upskilling program.

An example of the second phase is depicted in FIG. 3, where the system can structure and evaluate the processed data to determine a set of pertinent candidate characterization values. In different embodiments, the system can perform some or all the following operations:
(a) identify candidate skills and, for each skill, their current skill strength (step 310)
(b) identify candidate experience level and specific experiences (step 320)
(c) identify candidate certifications (step 330)
(d) identify candidate aspirations (step 340)
(e) identify candidate's domain and technology areas, such as finance, telecom, banking, etc. (step 350)
(f) pass the information from operations (a)-(e) to a combination ML model to obtain a ‘big picture’ scope of the candidate's profile and potential
(g) suggest next actions best suited to the candidate, such as what skills they should pursue, how much time they should invest in upgrading their skill set, and what specific training protocols they should complete (step 370)
(h) identify the candidate's behavioral traits, generate customized feedback, and determine their performance rating, which can include feedback by SMEs who may be mentoring or guiding the individual (step 380)
(i) contextualize the candidate's characteristics per operations (a)-(e) within the larger landscape of market trends and expected industry transformations (step 390)
(j) predict one or more potential future roles in which the candidate may excel (step 392)

In one example, the prediction of the candidate's potential future roles can be obtained by a formula described in Equation (1) below:

$$P ( successful future roles ) = f ( Σ [ ( {S}_{i j}^{2} + {C}_{i k}^{2} + {T}_{i j}^{2} + {D}_{i k}^{2} + {A}_{i l}^{2} + {B}_{i m}^{2} + {F}_{j n}^{2} + {G}_{k o}^{2} ) / ( n \times m \times p \times q \times r \times s \times t \times u ) ] \times \frac{\int ( 1 + α ) d x \times d [ ( 1 + β ) \times ( 1 + γ ) ]}{d t} \times θ ) \qquad Equation ( 1 )$$

where:
Sᵢⱼ represents the skill level of the i-th individual in the j-th;
Cᵢₖ represents the number of certifications completed by the i-th individual in the k-th certification category;
Tᵢⱼ represents the experience in years of the i-th individual in the j-th technology category;
Dᵢₖ represents the domain knowledge of the i-th individual in the k-th domain category;
Aᵢₗ represents the aspirations of the i-th individual in the I-th aspiration category;
Bᵢₘ represents the behavioral traits of the i-th individual in the m-th trait category;
Fⱼₙ represents the feedback received by the i-th individual in the n-th feedback category;
Gₖₒ represents the performance ratings of the i-th individual in the o-th rating category;
n, m, p, q, r, s, t, and u are the total number of skills, certifications, technology, domain, aspiration, trait, feedback, and rating categories, respectively;
α, β, and γ are weights for the importance of skill, certification, and technology, respectively (e.g., α=0.5, β=0.3, γ=0.2); and
θ is a factor that accounts for external factors that may impact future roles, such as market trends and economic conditions.

In different embodiments, the output of Equation (1) can represent a prediction of what specific roles a candidate may excel in going forward. This prediction can take into account not only the individual's skills, certifications, experience, domain knowledge, aspirations, and personality traits, but also feedback received, performance ratings, and external factors that may impact future roles. It can be appreciated that the quadratic components add additional complexity and allow for non-linear relationships between the factors. The integral and the weights allow for the importance of different factors to be adjusted. The additional factor θ accounts for external factors that may impact future roles, making the formula more comprehensive and tailored to the individual, further improving accuracy of the prediction.

In some embodiments, once the prediction has been calculated, the system can further generate an overall score that can be used to identify the best course of action for developing an individual's talent. One example of a formula by which such a score may be obtained is given in Equation 2 below.

$${Σ [ ( {S}_{i j}^{2} + {C}_{i k}^{2} + {T}_{i j}^{2} + {D}_{i k}^{2} + {A}_{i l}^{2} + 2 {S}_{i j} {C}_{i k} + 2 {S}_{i j} {T}_{i j} + 2 {S}_{i j} {D}_{i k} + 2 {S}_{i j} {A}_{i l} + 2 {C}_{i k} {T}_{i j} + 2 {C}_{i k} {D}_{i k} + 2 {C}_{i k} {A}_{i l} + 2 {T}_{i j} {D}_{i k} + 2 {T}_{i j} {A}_{i l} + 2 {D}_{i k} {A}_{i l} ) / ( n \times m \times p \times q \times r ) ]}^{2} \times \int ( 1 + α {x}^{2} ) d x \times d [ ( 1 + β {y}^{2} ) \times ( 1 + γ {z}^{2} ) ] / dt \times P ( successful future roles ) \qquad Equation ( 2 )$$

In different embodiments, the output of Equation (2) can represent the ‘next best action’ identifier score for the individual in the talent building framework. As indicated by each variable included in the formula, the score is determined by taking into account the individual's skill level, certifications completed, experience in years, domain knowledge, and aspirations in different categories. To calculate the score, Equation (2) applies a summation notation that adds up the scores for each individual and skill category. Each score is then determined by adding up the individual's skill level, certifications completed, experience in years, domain knowledge, and aspirations for that specific category, and then dividing by the total number of categories in each of those five areas to normalize the output and ensure individuals and skills are being compared on an equal basis.

In other words, the score can indicate the recommended target skills for a particular candidate (toward what skill should the candidate upgrade themselves) along with the duration needed for the candidate to acquire each of those skills. As one non-limiting example, the system may have reference to thousands, or tens of thousands or more unique combinations of skills and training duration. In one example, the talent engine can also determine which job descriptions include the top matching skills identified by the skill repository ML model 224 (FIG. 2), and for each of these roles, which job requires skills that would be easiest or take the shortest period of time for the candidate to become proficient in. In other words, what combination of skills appears to provide the most efficient path toward upskilling for the candidate in the context of the organization's goals.

In addition, the formula incorporates quadratic and linear equations, as well as integration and differentiation. In some embodiments, these components can be understood to enrich the score by adding complexity and depth to the formula, which can help to more accurately reflect the individual's potential and future opportunities. The quadratic components in particular can help to account for the potential synergies between different skills and certifications, and the integration and differentiation components help to track changes in an individual's abilities over time. Furthermore, in different embodiments, the integration and differentiation components in the formula serve as mathematical tools that enable the weightings to be adjusted or tweaked for the different factors that contribute to score based on the priorities or goals of the organization. In other words, the weights can be distributed to reflect the target needs of the organization, and can be selected by the organization and modified when needed. In some embodiments, the integration and differentiation components can be used to further refine the scores and provide a more accurate representation of an individual's potential. For example, integration and differentiation components help to track changes in an individual's abilities over time based on their regular assessments or evaluations (check-ins). Thus, if the individual were to commit, within the next week, to participating the system-recommended up-skilling program that extends over two weeks, the system can predict that their proficiency will have increased after three weeks. This change in proficiency can then be accommodated by the system when identifying his/her future roles.

In addition, by taking the derivative of the (1+β)*(1+γ) term with respect to time (dt), the system can adjust the rate at which the importance of certifications and technologies changes over time. Similarly, the indefinite integral of the (1+α) term with respect to the x term allows the system to adjust the weight given to different skill levels. Finally, by integrating or differentiating these terms, the system can fine-tune the formula to prioritize different factors based on their current and future importance. In essence, integration and differentiation help make the formula more flexible and adaptable to changing talent requirements over time. In some embodiments, the final score can then be multiplied by weighted factors (α, β, and γ) that reflect the importance of different factors in determining an individual's potential. These factors can be further adjusted to prioritize different areas depending on the specific needs of the talent building framework. Based on these calculations, which are performed again as the individual's assessment data are received, the system can recommend not only a best action to the user but a road map they can refer to when navigating toward that action.

As noted earlier, the system can rely on one or more ML models to generate its predictions and scoring. In different embodiments, the ML model can take into consideration various factors including the candidate's skills, certifications, experience, domain knowledge, and aspirations to provide a personalized training journey. In addition, the ML model is designed to continuous learns and adapt to the latest industry trends and job requirements, ensuring that the training plan is always up-to-date and relevant. Furthermore, training of the model is conducted using vast amounts of data and fine-tuned to deliver the most accurate and relevant recommendations.

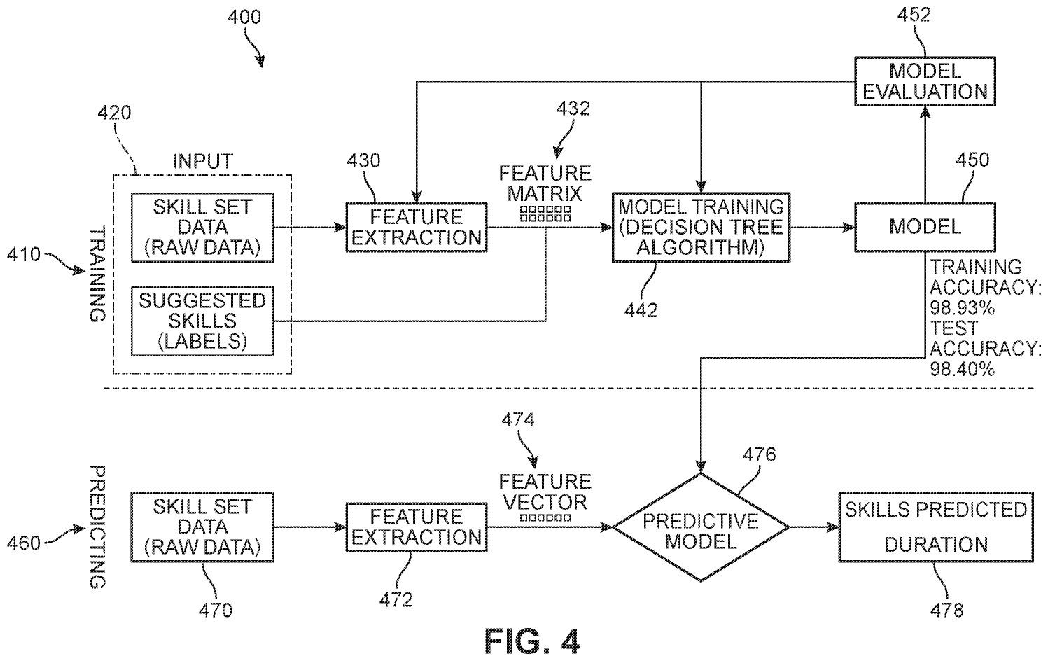

One example of a training and prediction process 400 that implements an ML model 450 is depicted in FIG. 4. In this process 400, an ongoing training phase 410 can be used to create and improve the model 450 over time. In one example, training data 420 including a dataset of skills (raw) and labels for each skill (so labelled data) can be entered as input to the system. At a first feature extraction module 430, features are extracted from the skill set data and used, along with the suggested skills, to obtain a feature matrix 432. The feature matrix 432 is passed to a model training module 442 that can implement a decision tree algorithm to develop the model 450 based on the labeled data. The model 450 can iteratively be evaluated to track accuracy of the predictions and model evaluation data 452 shared with both the model training module 442 and the first feature extraction module 430 as feedback to improve the performance of the model 450. In some embodiments, the model 450 can then be used by the system in real-case scenarios. For example, during a predictive phase 460, real-time data 470 for a candidate can be received by the system. Features are extracted by a second feature extraction module 472, producing a feature vector 474 that is passed to a predictive model 476 (which incorporates the trained model 450) to generate output 478 a set of predicted skills and duration to proficiency for the candidate. Thus, the system is able to generate a personalized and effective upskilling program that is tailored to each candidate's unique needs and goals.

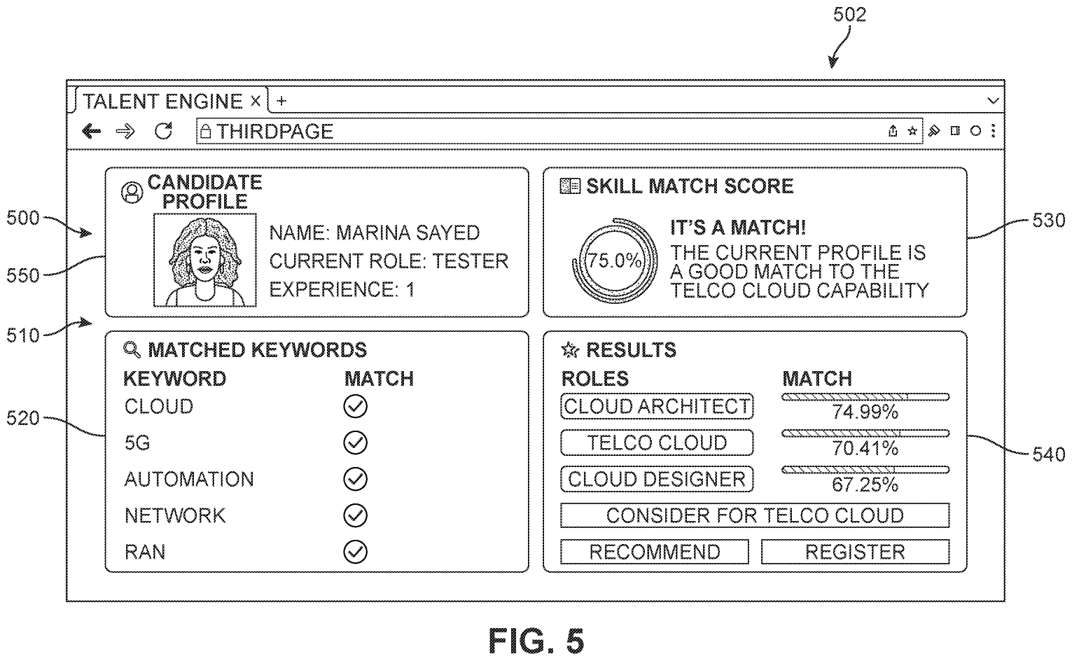

For purposes of illustration, one example of an application (“app”) 500 implementing an embodiment of talent management system is now described. For this example, a series of user interfaces are depicted across FIGS. 5, 6, 7, 8, and 9. The user interfaces are shown only as an example, and should not be understood to limit the performance of the described systems and methods. As noted earlier, the system is based on a robust analytical engine which has access to thousands of mapping between job descriptions, skills (e.g., stored in a skills repository), extracts the top identified matches, and correlates this information with candidate-specific inputs that are provided to the system to determine the skill match percentage in the context of a target job description. In some embodiments, candidate details from their resume are automatically captured in preparation for the candidate's access to the portal. In one example, a message (e.g., email) can be automatically generated and sent to the candidate with a link to the app 500.

One example of a candidate profile that has been processed by the system is shown in a candidate prediction interface 510 in FIG. 5. In different embodiments, the system can identify the candidate information (e.g., a first candidate 550 “Marina Sayed”) as well as a set of keywords 520 that were extracted from her resume and matched a given job description. In addition, the ML model has generated a skill match score 530 that represents the strength of the first candidate's profile's match with the skillset (e.g., telco cloud capability). Furthermore, a results panel 540 shows some of the roles that have been identified as representing future successful roles for the first candidate 550, such as cloud architect, telco cloud, and cloud designer, as well as their respective match strength percentage. In other words, the AI-powered engine described herein has delivered a highly accurate skill match score aligned to current role requirements and registering this match as a potential candidate for that particular role.

As discussed earlier, in different embodiments, the system can ingest data specific to an individual candidate and identify potential skillset matches for which the candidate would most likely flourish and, upon completion of their training in such skills, would enable them to fill a needed role in the organization. It can be appreciated that once some target skills are identified by the model and recommended for adoption to a candidate, in order for the system to maintain the most up-to-date information about a candidate, regular testing or evaluations should be made of the candidate to determine whether they have made progress in their journey toward the target skillset. For example, the system can present assessments that are designed to capture the experience of the candidate, and also verify his/her knowledge as related to their past roles. In some embodiments, these assessments can more finely determine the candidate's knowledge in a specific domain. The results of these assessments can be used by the system to automatically modify/update the candidate's training path and selected modules when appropriate.

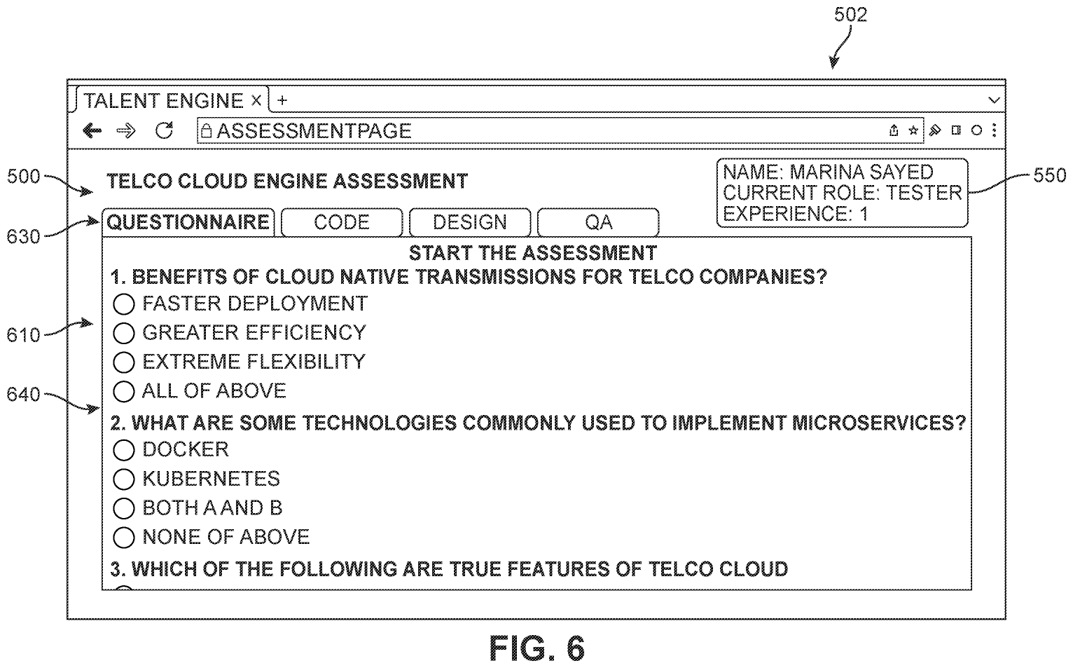

Thus, in some embodiments, the app 500 can include provisions for collecting data that can be used to determine the candidate's current proficiency and/or awareness in a particular knowledge area. For example, depending on the experience needed for the recommended role, and the advice of the associated SME or domain expert, the candidate may be requested to work through a series of case studies, questionnaires, and live simulations targeting the required skills. In order to determine if the candidate has successfully completed these learning modules, the system may provide recurring evaluations. Referring to FIG. 6, an example of an automatically generated assessment interface 610 for app 500 is depicted. For purposes of this example, the first candidate 550 (“Marina Sayed”) with a current role of tester and one year experience in her role, was previously evaluated by the system as described with respect to FIGS. 2 and 3 above. Her predicted successful future role was identified as being directed to telco technologies, and she was recommended to attend to a series of online course modules through the system that would train her in this skillset. The system has tracked her progress through this training protocol and, after a first period of time from the prediction, automatically requests her participation in the knowledge test. In this case, the assessment interface 610 includes a series of questions that assess her knowledge based on the content that she has engaged with during the past week via the system-provided course module. Three questions are presented in FIG. 6 simply as an example.

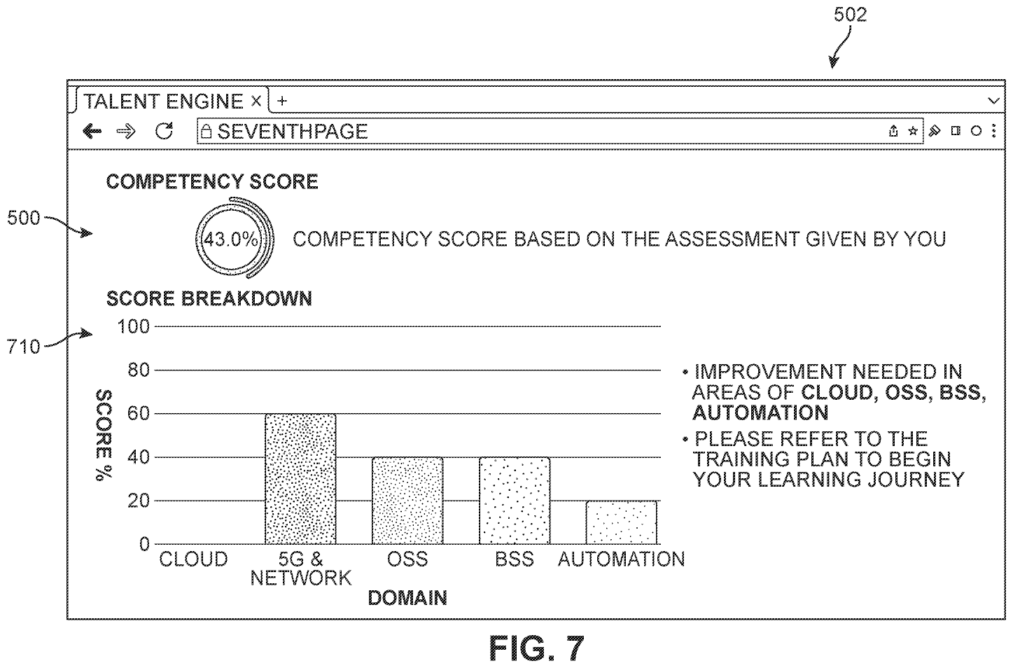

In some embodiments, the system can also test the first candidate's ability to code and/or design (see menu tabs 630) or perform other functions that are related to the target skillset, and/or provide written answers in a Q & A. Each of these channels allow the system to monitor the candidate's progress through the training that was recommended to her and identify areas of strength and areas of weakness that can be reinforced. In other words, the system can present regular assessments to the candidate to validate or identify his/her current skill strength. The results of these assessments can be presented to the candidate and/or communicated to their manager(s). For example, a scoring dashboard 710 is shown in FIG. 7 that offers a graphical feedback of the candidate's overall competency score (e.g., 43%) for the selected skillset, as well as options to view further details about their score (e.g., score breakdown bar chart) that can more finely define their proficiency with respect to subsets of skills (domains) in this skillset. For purposes of this example, the score breakdown of FIG. 6 reflects their knowledge in several domains including cloud, 5G and Network, OSS, BSS, and automation. In some embodiments, more minute details about their assessment, including a description of their problem areas, can be presented, and a history of their scores and performance accessed. In some cases, a candidate's initial skill match score for a role may be higher, but upon more in-depth analysis the system may downgrade their score when it is revealed that their actual current skills are less impressive, or vice-versa.

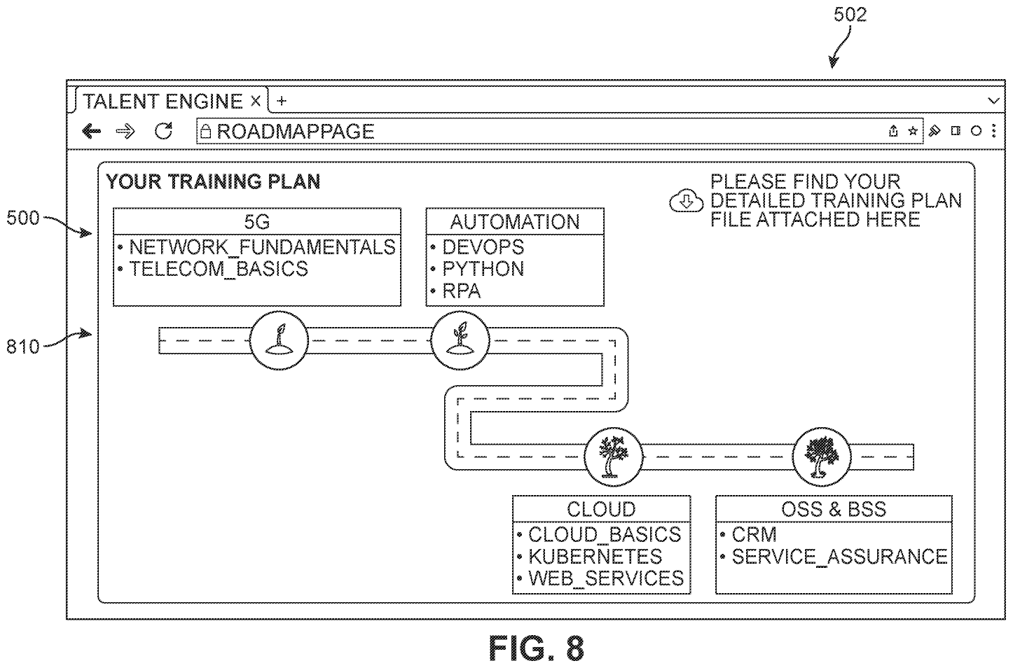

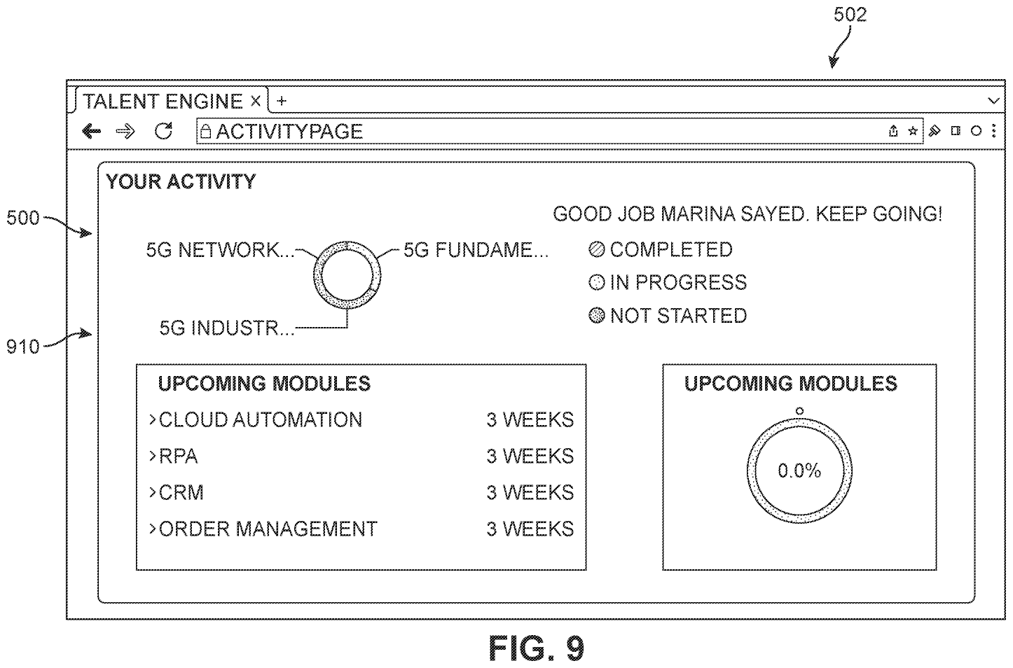

Referring to FIGS. 8 and 9, in different embodiments, the candidate may also access their learning path or training plan 810 via app 500 (e.g., see FIG. 8) and/or review their account activity 910 and/or upcoming schedule and goals, and the expected duration attached to completion of each module/skillset (e.g., see FIG. 9). In one example, the training plan is an AI-generated personalized learning path for the user that is tailor selected from thousands of combinations and possibilities. The system seeks to identify matches between the user's experience, current skill strength, and certifications, etc. with the available learning modules to ensure their learning is tailored to their unique needs and goals. The upskilling journey is aligned to a specific candidate and this order can change over time to accommodate the candidate's dynamic skill sets and levels. The learning path also takes into consideration external factors like changing market trends, industry transformations, etc. that may impact future roles.

In some embodiments, the training path can be modified in response to updated data about the candidate's proficiency in a particular domain. For example, while a candidate may have been considered highly proficient in a domain one year ago, their proficiency may be lower now as the underlying knowledge has advanced and changed over the year. Thus, what was a skill strength one year ago has become less useful. Thus, the training path can accommodate these fluctuations in domain knowledge that occur as advances in technology and methodologies take place in the real-world. The system is thereby able to continuously assess the candidate's skills and identify knowledge gaps that are based on the most current market trends to ensure the predictions and recommended personalized training paths are aligned with the actual state of the field and their relative experience.

Furthermore, in some embodiments, the system can also automatically assign a (human) SME or mentor to the individual candidate. The SME can be selected from a directory of SMEs listed in the system's database who have been identified as potential guides for candidates during their upcoming learning paths. In some embodiments, the system can receive the assigned mentor's feedback when determining the proficiency of the candidate from one time period to the next, including a performance rating, and any outstanding behavioral traits.

It can be appreciated that the proposed framework can enable companies to quickly identify the skill sets available for each human resource in the organization, as well as identify specific combinations of skill sets that are available. In addition, in cases where a role must be filled and no one within the company at that time has the full array of skills that are needed for that role, the system can alternatively identify persons who are partial matches and then automatically generate a training path that will bring these persons to proficiency in each domain that target the required combination of skills for that role.

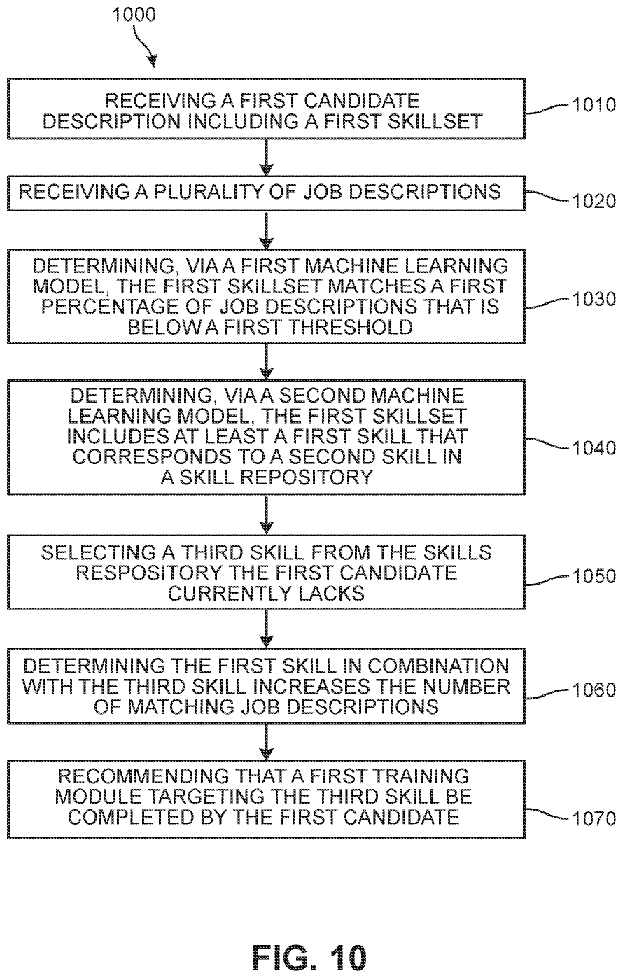

FIG. 10 is a flow chart illustrating an embodiment of a method 1000 of controlling a system to generate and interactively implement a customized learning path. The method 1000 includes a first step 1010 of receiving, at a talent management system, a first candidate description for a first candidate including a first skillset, and a second step 1020 of receiving, at the talent management system, a dataset including a plurality of job descriptions. A third step 1030 includes determining, via a first machine learning model of the talent management system, the first candidate description with the first skillset matches a first percentage of job descriptions from the plurality of job descriptions, the first percentage falling below a first threshold. In addition, a fourth step 1040 includes determining, via a second machine learning model of the talent management system, the first skillset includes at least a first skill that corresponds to a second skill in a skill repository. A fifth step 1050 includes selecting, at the talent management system and by reference to the skills repository, a third skill that the first candidate currently lacks, the third skill selected based on its relationship to one or more of certifications, experiences, domain knowledge, aspirations, and personality traits associated with the first candidate. Furthermore, a sixth step 1060 includes determining, at the talent management system, the first skill in combination with the third skill increases the number of matching job descriptions, and a seventh step 1070 includes presenting to a user, via an interface display of the talent management system, a recommendation that a first training module targeting the third skill be completed by the first candidate.

In other embodiments, the method may include additional steps or aspects. In some embodiments, the method also includes generating a customized learning path including a sequence of training modules, where the sequence can be determined by the talent management system based on the first skillset. In some embodiments, the method further includes presenting, at an application for the talent management system, a first assessment interface including at least a first question regarding content associated with the first skill, receiving, via the application and at the talent management system, a first response to the first question, and automatically updating the customized learning path based on the first response. In another embodiment, the method can also include steps of selecting, via the talent management system, a first human mentor from a mentor database associated with the talent management system, the selection being based on the first human mentor's proficiency with the third skill, updating the customized learning path to include one or more training modules that involve interaction with the first human mentor, receiving, at the talent management system, feedback from the first human mentor, and automatically updating, at the talent management system, the customized learning path based on the feedback.

In different embodiments, the method can further include steps of assigning a first human mentor to the first candidate, receiving, at the talent management system, feedback from the first human mentor, and automatically updating the customized learning path based on the feedback to require an additional training module involving an interaction with the first human mentor. In one example, the method can include additional steps of receiving, at the talent management system, an indication that the first training module has been successfully completed, presenting, at an application for the talent management system, a first assessment interface including questions regarding content associated with the third skill, receiving, via the application and at the talent management system, responses to the questions, determining, at the talent management system, that the first candidate is now proficient in the third skill based on the responses, and automatically updating the first skillset associated with the first candidate description to include the third skill. In some embodiments, the method can further include determining, via the first machine learning model, the first candidate description with the updated first skillset matches a second percentage of job descriptions from the plurality of job descriptions, wherein the second percentage is greater than the first percentage.

In another example, the method can also include receiving, at the talent management system, an indication that the first training module has been successfully completed, and presenting to the user, via the interface display, an updated recommendation that a second training module further targeting the third skill be completed next by the first candidate. In one embodiment, the method also includes predicting, by the talent management system, a duration during which the first candidate can become proficient in the third skill. In some embodiments, the first threshold is selected by the organization based on the desired development goals and alignment levels of the organization. For example, a higher threshold can be selected if the organization intends that a larger number of candidates experience the upskilling protocol or program and/or have a customized learning path generated and/or the organization is intending to grow/develop quickly in the near future. In contrast, a lower percentage can be selected if the organization is looking to limit the number of candidates who pass through the upskilling program.

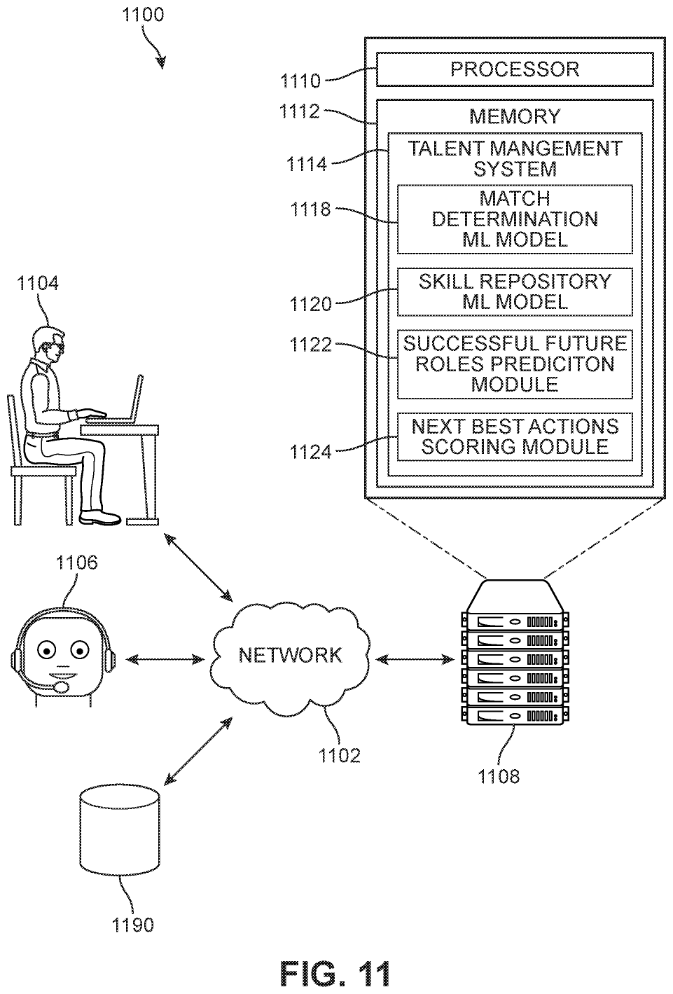

FIG. 11 is a schematic diagram of an environment 1100 for an intelligent talent management system 1114 (“system” 1114), according to an embodiment. The environment 1100 may include a plurality of components capable of performing the disclosed methods. For example, environment 1100 includes a user device 1104, a computing/server system 1108, and a database 1190. The components of environment 1100 can communicate with each other through a network 1102. For example, user device 1104 may retrieve information from database 1190 via network 1102. In some embodiments, network 1102 may be a wide area network (“WAN”), e.g., the Internet. In other embodiments, network 1106 may be a local area network (“LAN”).

As shown in FIG. 11, components of the system 1114 may be hosted in computing system 1108, which may have a memory 1112 and a processor 1110. Processor 1110 may include a single device processor located on a single device, or it may include multiple device processors located on one or more physical devices. Memory 1112 may include any type of storage, which may be physically located on one physical device, or on multiple physical devices. In some cases, computing system 1108 may comprise one or more servers that are used to host the system.

While FIG. 11 shows one user device, it is understood that one or more user devices may be used. For example, in some embodiments, the system may include two or three user devices. In some embodiments, the user device may be a computing device used by a user. For example, user device 1104 may include a smartphone or a tablet computer. In other examples, user device 1104 may include a laptop computer, a desktop computer, and/or another type of computing device. The user devices may be used for inputting, processing, and displaying information. Referring to FIG. 11, environment 1100 may further include database 1190, which stores candidate descriptions, job descriptions, labeled training data, learning modules/training courses, mentor directories, market predictions, skill repository, skill combinations, assessments, candidate account and profiles, feedback data, and/or other related data for the components of the system as well as other external components. This data may be retrieved by other components for system 1114. As discussed above, system 1114 may include a first ML model (match determination ML model 1118), a second ML model (skill repository ML model 1120), a successful future roles prediction module 1122, and a next-best actions/recommended roles scoring module 1124. Each of these modules/components may be used to perform the operations described herein.

For purposes of this application, an “interface” may be understood to refer to a mechanism for communicating content through a client application to an application user. In some examples, interfaces may include pop-up windows that may be presented to a user via native application user interfaces (UIs), controls, actuatable interfaces, interactive buttons/options or other objects that may be shown to a user through native application UIs, as well as mechanisms that are native to a particular application for presenting associated content with those native controls. In addition, the terms “actuation” or “actuation event” refers to an event (or specific sequence of events) associated with a particular input or use of an application via an interface, which can trigger a change in the display of the application. Furthermore, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls. The term “asset” refers to content that may be presented in association with a native control in a native application. As some non-limiting examples, an asset may include text in an actuatable pop-up window, audio associated with the interactive click of a button or other native application object, video associated with the user interface, or other such information presentation.

It should be understood that the text, images, and specific application features shown in the figures are for purposes of illustration only and in no way limit the manner by which the application may communicate or receive information. In addition, in other embodiments, one or more options or other fields and text may appear differently and/or may be displayed or generated anywhere else on the screen(s) associated with the client's system, including spaced apart from, adjacent to, or around the user interface. In other words, the figures present only one possible layout of the interface, and do not in any way limit the presentation arrangement of any of the disclosed features.

Embodiments may include a non-transitory computer-readable medium (CRM) storing software comprising instructions executable by one or more computers which, upon such execution, cause the one or more computers to perform the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid state disk), a compact disc (CD), a digital versatile disc (DVD), a floppy disk, a cartridge, and/or a magnetic tape.

To provide further context, in some embodiments, some of the processes described herein can be understood to operate in a system architecture that can include a plurality of virtual local area network (VLAN) workstations at different locations that communicate with a main data center with dedicated virtual servers such as a web server for user interfaces, an app server for data processing, a database for data storage, etc. As a general matter, a virtual server is a type of virtual machine (VM) that is executed on a hardware component (e.g., server). In some examples, multiple VMs can be deployed on one or more servers.

In different embodiments, the system may be hosted at least in part in a cloud computing environment offering ready scalability and security. The cloud computing environment can include, for example, an environment that hosts the document processing management service. The cloud computing environment may provide computation, software, data access, storage, etc. services that do not require end-user knowledge of a physical location and configuration of system(s) and/or device(s) that hosts the policy management service. For example, a cloud computing environment may include a group of computing resources (referred to collectively as “computing resources” and individually as “computing resource”). It is contemplated that implementations of the present disclosure can be realized with appropriate cloud providers (e.g., AWS provided by Amazon™, GCP provided by Google™, Azure provided by Microsoft™, etc.).

The methods, devices, and processing described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A computer-implemented method of controlling a system to generate and interactively implement a customized learning path, the method comprising:
receiving, at a talent management system, a first candidate description for a first candidate including a first skillset;
receiving, at the talent management system, a dataset including a plurality of job descriptions;
determining, via a first machine learning model of the talent management system, the first candidate description with the first skillset matches a first percentage of job descriptions from the plurality of job descriptions, the first percentage falling below a first threshold;
determining, via a second machine learning model of the talent management system, the first skillset includes at least a first skill that corresponds to a second skill in a skill repository;
selecting, at the talent management system and by reference to the skills repository, a third skill that the first candidate currently lacks, the third skill selected based on its relationship to one or more of certifications, experiences, domain knowledge, aspirations, and personality traits associated with the first candidate;
determining, at the talent management system, the first skill in combination with the third skill increases the number of matching job descriptions; and
presenting to a user, via an interface display of the talent management system, a recommendation that a first training module targeting the third skill be completed by the first candidate.

2. The method of claim 1, further comprising generating a customized learning path including a sequence of training modules, the sequence determined by the talent management system based on the first skillset.

3. The method of claim 2, further comprising:
presenting, at an application for the talent management system, a first assessment interface including at least a first question regarding content associated with the first skill;
receiving, via the application and at the talent management system, a first response to the first question; and
automatically updating the customized learning path based on the first response.

4. The method of claim 2, further comprising:
selecting, via the talent management system, a first human mentor from a mentor database associated with the talent management system, the selection being based on the first human mentor's proficiency with the third skill;
updating the customized learning path to include one or more training modules that involve interaction with the first human mentor;
receiving, at the talent management system, feedback from the first human mentor; and
automatically updating, at the talent management system, the customized learning path based on the feedback.

5. The method of claim 1, further comprising:
assigning a first human mentor to the first candidate;
receiving, at the talent management system, feedback from the first human mentor; and
automatically updating the customized learning path based on the feedback to require an additional training module involving an interaction with the first human mentor.

6. The method of claim 1, further comprising:
receiving, at the talent management system, an indication that the first training module has been successfully completed;
presenting, at an application for the talent management system, a first assessment interface including questions regarding content associated with the third skill;
receiving, via the application and at the talent management system, responses to the questions;
determining, at the talent management system, that the first candidate is now proficient in the third skill based on the responses; and
automatically updating the first skillset associated with the first candidate description to include the third skill.

7. The method of claim 6, further comprising determining, via the first machine learning model, the first candidate description with the updated first skillset matches a second percentage of job descriptions from the plurality of job descriptions, wherein the second percentage is greater than the first percentage.

8. The method of claim 1, further comprising:
receiving, at the talent management system, an indication that the first training module has been successfully completed; and
presenting to the user, via the interface display, an updated recommendation that a second training module further targeting the third skill be completed next by the first candidate.

9. The method of claim 1, further comprising predicting, by the talent management system, a duration during which the first candidate can become proficient in the third skill.

10. A non-transitory computer-readable medium storing software comprising instructions executable by one or more computers which, upon such execution, cause the one or more computers to control a system to generate and interactively implement a customized learning path by performing the following:
receive, at a talent management system, a first candidate description for a first candidate including a first skillset;
receive, at the talent management system, a dataset including a plurality of job descriptions;
determine, via a first machine learning model of the talent management system, the first candidate description with the first skillset matches a first percentage of job descriptions from the plurality of job descriptions, the first percentage falling below a first threshold;
determine, via a second machine learning model of the talent management system, the first skillset includes at least a first skill that corresponds to a second skill in a skill repository;
select, at the talent management system and by reference to the skills repository, a third skill that the first candidate currently lacks, the third skill selected based on its relationship to one or more of certifications, experiences, domain knowledge, aspirations, and personality traits associated with the first candidate;
determine, at the talent management system, the first skill in combination with the third skill increases the number of matching job descriptions; and
present to a user, via an interface display of the talent management system, a recommendation that a first training module targeting the third skill be completed by the first candidate.

11. The non-transitory computer-readable medium storing software of claim 10, wherein the instructions further cause the one or more computers to generate a customized learning path including a sequence of training modules, the sequence determined by the talent management system based on the first skillset.

12. The non-transitory computer-readable medium storing software of claim 11, wherein the instructions further cause the one or more computers to:
present, at an application for the talent management system, a first assessment interface including at least a first question regarding content associated with the first skill;
receive, via the application and at the talent management system, a first response to the first question; and
automatically update the customized learning path based on the first response.

13. The non-transitory computer-readable medium storing software of claim 11, wherein the instructions further cause the one or more computers to:
select, via the talent management system, a first human mentor from a mentor database associated with the talent management system, the selection being based on the first human mentor's proficiency with the third skill;
update the customized learning path to include one or more training modules that involve interaction with the first human mentor;
receive, at the talent management system, feedback from the first human mentor; and
automatically update, at the talent management system, the customized learning path based on the feedback.

14. The non-transitory computer-readable medium storing software of claim 10, wherein the instructions further cause the one or more computers to:
assign a first human mentor to the first candidate;
receive, at the talent management system, feedback from the first human mentor; and
automatically update the customized learning path based on the feedback to require an additional training module involving an interaction with the first human mentor.

15. A system for controlling a system to generate and interactively implement a customized learning path comprising one or more computers and one or more storage devices storing instructions that are operable, when executed by the one or more computers, to cause the one or more computers to:
receive, at a talent management system, a first candidate description for a first candidate including a first skillset;
receive, at the talent management system, a dataset including a plurality of job descriptions;
determine, via a first machine learning model of the talent management system, the first candidate description with the first skillset matches a first percentage of job descriptions from the plurality of job descriptions, the first percentage falling below a first threshold;
determine, via a second machine learning model of the talent management system, the first skillset includes at least a first skill that corresponds to a second skill in a skill repository;
select, at the talent management system and by reference to the skills repository, a third skill that the first candidate currently lacks, the third skill selected based on its relationship to one or more of certifications, experiences, domain knowledge, aspirations, and personality traits associated with the first candidate;
determine, at the talent management system, the first skill in combination with the third skill increases the number of matching job descriptions; and
present to a user, via an interface display of the talent management system, a recommendation that a first training module targeting the third skill be completed by the first candidate.

16. The system of claim 15, wherein the instructions further cause the one or more computers to:
receive, at the talent management system, an indication that the first training module has been successfully completed;
present, at an application for the talent management system, a first assessment interface including questions regarding content associated with the third skill;
receive, via the application and at the talent management system, responses to the questions;
determine, at the talent management system, that the first candidate is now proficient in the third skill based on the responses; and
automatically update the first skillset associated with the first candidate description to include the third skill.

17. The system of claim 16, wherein the instructions further cause the one or more computers to determine, via the first machine learning model, the first candidate description with the updated first skillset matches a second percentage of job descriptions from the plurality of job descriptions, wherein the second percentage is greater than the first percentage.

18. The system of claim 15, wherein the instructions further cause the one or more computers to:
receive, at the talent management system, an indication that the first training module has been successfully completed; and
present to the user, via the interface display, an updated recommendation that a second training module further targeting the third skill be completed next by the first candidate.

19. The system of claim 15, wherein the instructions further cause the one or more computers to predict, by the talent management system, a duration during which the first candidate can become proficient in the third skill.

20. The system of claim 15, wherein the instructions further cause the one or more computers to generate a customized learning path including a sequence of training modules, the sequence determined by the talent management system based on the first skillset.
